(19) United States
(12) Patent Application Publication
(10) Pub. No.: US 2014/0122017 A1
(43) Pub. Date: May 1, 2014

(54) FLUORESCENT SOCKET CONNECTOR HAVING BEACON MODULE FOR INDOOR POSITIONING, AND INDOOR POSITIONING SYSTEM USING THE SAME

(71) Applicant: Kyo Koan CHU, Daegu (KR)

(72) Inventor: Kyo Koan CHU, Daegu (KR)

(73) Assignee: WINITECH CO., LTD., Daegu (KR)

(21) Appl. No.: 13/773,333

(22) Filed: Feb. 21, 2013

(30) Foreign Application Priority Data
Nov. 1, 2012 (KR) 10-2012-0123104

(51) Int. Cl. G01S 5/02; H05B 41/14

(52) U.S. Cl. CPC G01S 5/0284; H05B 41/14
USPC 702/150; 315/200 R

(57) ABSTRACT

A fluorescent socket connector having a beacon module for indoor positioning and an indoor positioning system using the same are provided. The fluorescent socket connector includes a power supply unit, an AC/DC converter, and an indoor positioning beacon module. The power supply unit supplies an Alternating Current (AC) power source to power source terminals of a fluorescent lamp. The AC/DC converter receives an input of the AC power source, converts the AC power source into a Direct Current (DC) power source, and supplies a driving power source to the indoor positioning beacon module. The indoor positioning beacon module periodically wireless transmits a beacon signal including a beacon IDentifier (ID) to the external.

### CROSS REFERENCES

This application claims the benefit of Korean Patent Application No. 10-2012-0123104, filed 1 Nov. 2012, which is hereby incorporated by reference in its entirety into this application.

### BACKGROUND OF THE INVENTION

1. Field of the Invention

The present invention relates to a fluorescent socket connector having a beacon module for indoor positioning, and an indoor positioning system using the same. More particularly, the present invention relates to a technology capable of simply building an indoor positioning system at a low cost, by installing a beacon module for indoor positioning in a fluorescent socket connector coupled to a fluorescent light to make accurate indoor positioning possible.

2. Description of the Related Art

In recent years, an initial Global Positioning System (GPS) technology developed for military use is being widely used for civilian purposes of navigation, measurement, cartography and the like. Also, even a Location Based Service (LBS) using a GPS receiver as a positioning sensor has been commercialized.

But, it frequently occurs that the GPS receiver cannot receive a GPS satellite signal within doors, a metropolitan area of many high-rise buildings, an underground parking lot, a subway, a tunnel and the like. For this reason, there is a problem that the GPS receiver cannot provide consecutive user location information to a user indoors.

To fix this problem, many researches have been made on an indoor positioning technology of installing an Access Point (AP) within a building and enabling the AP to locate a target within doors using a Radio Frequency (RF) signal, and a service based on this. Active researches have been made on wireless indoor positioning technologies using infrared rays, ultrasonic waves and the like in addition to the RF signal.

The RF signal based indoor positioning technology is a technology of locating a target through a relative Received Signal Strength Indication (RSSI) received from a previously installed access point. The infrared ray based indoor positioning technology is a technology in which infrared sensors installed throughout the indoor recognize an infrared device having a unique IDentifier (ID) code and locate the infrared device. The ultrasonic wave based indoor positioning technology is a technology of locating a target using a transfer rate difference between a fast RF signal and a relative slow ultrasonic wave.

However, the aforementioned indoor positioning technologies excepting the ultrasonic wave based indoor positioning technology have a disadvantage of generally not only causing a large measurement error but also requiring very many access points, infrared sensors or the like. Also, because even an error of positioning information measurement is great more than a few meters, many inconveniences of use are caused.

Owing to the characteristic in which an RF signal is difficult to permeate walls, in many cases, the RF signal based indoor positioning technology is difficult to detect an accurate current location of a user within doors and is also difficult to detect an accurate location of the user between floors. Further, owing to a limitation on a basic reception distance of infrared rays, the infrared ray based indoor positioning technology has a problem that service is restrictive, and the cost of system installation and maintenance is very high. Further, the ultrasonic wave based indoor positioning technology enables accurate measurement, but has a problem that the cost of system installation is very high.

That is, the conventional indoor positioning technologies have a problem of having to bear the investment cost for expensive system building, because they cannot implement indoor positioning if an expensive indoor positioning system is not equipped.

### SUMMARY OF THE INVENTION

An aspect of exemplary embodiments of the present invention is to address at least the problems and/or disadvantages and to provide at least the advantages described below. Accordingly, an aspect of exemplary embodiments of the present invention is to simply build an indoor positioning system at a low cost, by installing a beacon module for indoor positioning in a fluorescent socket connector coupled to a fluorescent light to make accurate indoor positioning possible.

According to one aspect of the present invention, a fluorescent socket connector is provided. The fluorescent socket connector includes a power supply unit, an AC/DC converter, and an indoor positioning beacon module. The power supply unit supplies an Alternating Current (AC) power source input from a main socket, to power source terminals of a fluorescent lamp. The AC/DC converter receives an input of the AC power source from the power supply unit, converts the received AC power source into a Direct Current (DC) power source, and supplies a driving power source to the indoor positioning beacon module. The indoor positioning beacon module periodically wireless transmits a beacon signal including a beacon IDentifier (ID) to the external. The fluorescent socket connector has a structure in which, in a state where the power source terminals of the fluorescent lamp are coupled to coupling grooves provided in one side surface of a housing of the fluorescent socket connector, if electrode terminals formed in the other side surface of the housing of the fluorescent socket connector are connected to the main socket, a power source supplied from the main socket is applied to the power source terminals of the fluorescent lamp through the electrode terminals and lights up the fluorescent lamp.

The coupling grooves may be constructed as a female socket of a form of being fitted to the power source terminals of the fluorescent lamp. The electrode terminals may be constructed as a male socket of a form of being plugged into the main socket.

According to another aspect of the present invention, a fluorescent socket connector is provided. The fluorescent socket connector includes an AC/DC converter and an indoor positioning beacon module. The AC/DC converter receives an input of an AC power source from a main socket, converts the received AC power source into a DC power source, and supplies a driving power source to an indoor positioning beacon module. The indoor positioning beacon module periodically wireless transmits a beacon signal including a beacon ID to the external. The fluorescent socket connector is of a card type having slit through-holes and, in a state where power source terminals of a fluorescent lamp are fixed and get in point contact with the slit through-holes, if the power source terminals of the fluorescent lamp are connected to the main socket, a power source supplied from the main socket is applied to the power source terminals of the fluorescent lamp and lights up the fluorescent lamp.

According to a further aspect of the present invention, a fluorescent socket connector is provided. The fluorescent socket connector includes a power supply unit, an AC/DC converter, and an indoor positioning beacon module. The power supply unit supplies an AC power source input from a main socket, to a Light Emitting Diode (LED) fluorescent lamp. The AC/DC converter receives an input of the AC power source from the power supply unit, converts the received AC power source into a DC power source, and supplies a driving power source to an indoor positioning beacon module. The indoor positioning beacon module periodically wireless transmits a beacon signal including a beacon ID to the external. The fluorescent socket connector has a structure in which, in a state where the LED fluorescent lamp is coupled to a 1st coupling through-hole provided in one side surface of a housing of the fluorescent socket connector and power source terminals of the LED fluorescent lamp are coupled to a 2nd coupling through-hole provided in the other side surface of the housing of the fluorescent socket connector, if the power source terminals of the LED fluorescent lamp are connected to the main socket, a power source supplied from the main socket is applied to the LED fluorescent lamp and lights up the LED fluorescent lamp.

The 1st coupling through-hole may be provided in a form capable of being coupled with a 1st connection part connected to the LED fluorescent lamp. The 2nd coupling through-hole may be provided in a form capable of being coupled with a 2nd connection part connected to the power source terminals of the LED fluorescent lamp. Electrical contact points may be provided in coupling portions of the 1st and 2nd coupling through-holes and the 1st and 2nd connection parts, respectively.

According to a yet another aspect of the present invention, an indoor positioning system is provided. The indoor positioning system includes one or more fluorescent socket connectors, a portable terminal, and a positioning server. The one or more fluorescent socket connectors are coupled to fluorescent lights, and have indoor positioning beacon modules for periodically wireless transmitting beacon signals including beacon IDs to the external. The portable terminal receives a beacon signal from the fluorescent socket connector located around the portable terminal through wireless communication, extracts a beacon ID from the received beacon signal, detects a strength of the beacon signal, and stores the extracted beacon ID and the detected strength of the beacon signal in a memory. The portable terminal periodically includes each of the beacon ID and the strength stored in the memory in a location estimation message and wireless transmits the location estimation message to the external. The positioning server receives the location estimation message from the portable terminal through the wireless communication, determines a location of a user who carries the portable terminal on the basis of information included in the received location estimation message, maps the determined location of the user on a map, and wireless transmits the mapped location to the portable terminal.

### BRIEF DESCRIPTION OF THE DRAWINGS

The above and other objects, features and advantages of the present invention will become more apparent from the following detailed description when taken in conjunction with the accompanying drawings in which:

FIGS. 1 and 2 are diagrams illustrating a fluorescent socket connector according to an exemplary embodiment of the present invention;

FIG. 3 is a diagram illustrating an indoor positioning system according to an exemplary embodiment of the present invention;

FIGS. 4A and 4B are diagrams illustrating a fluorescent socket connector according to another exemplary embodiment of the present invention;

FIGS. 5A, 5B and 5C are diagrams for describing a method of coupling the fluorescent socket connector of FIGS. 4A and 4B to power source terminals of a fluorescent lamp; and

FIGS. 6A and 6B are diagrams illustrating fluorescent socket connectors according to further exemplary embodiments of the present invention.

FIGS. 7A and 7B are diagrams illustrating fluorescent socket connectors according to further exemplary embodiments of the present invention.

Throughout the drawings, the same drawing reference numerals will be understood to refer to the same elements, features and structures.

### DETAILED DESCRIPTION OF THE INVENTION

Exemplary embodiments of the present invention will now be described in detail with reference to the annexed drawings.

In the following description, well-known functions or constructions are not described in detail since they would obscure the invention in unnecessary detail.

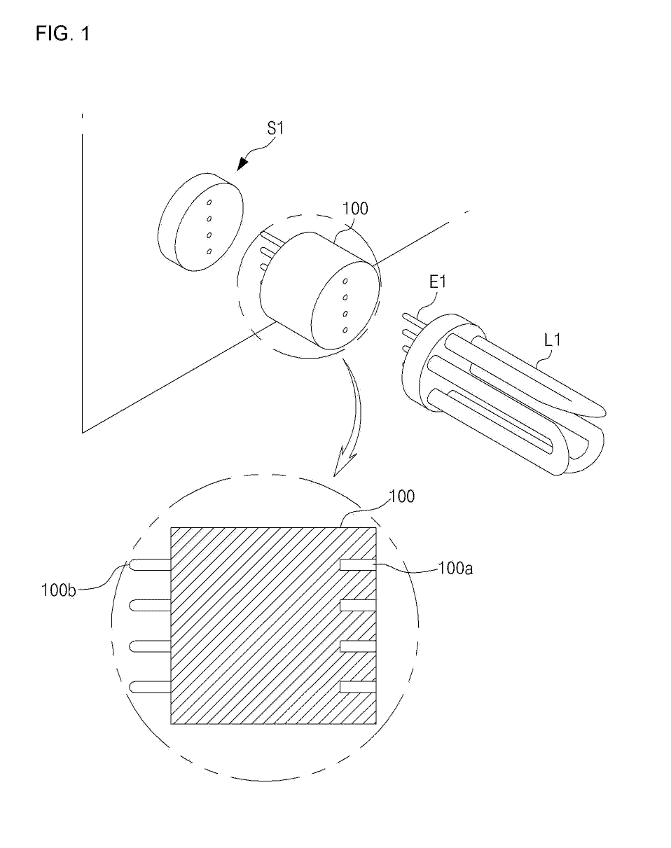

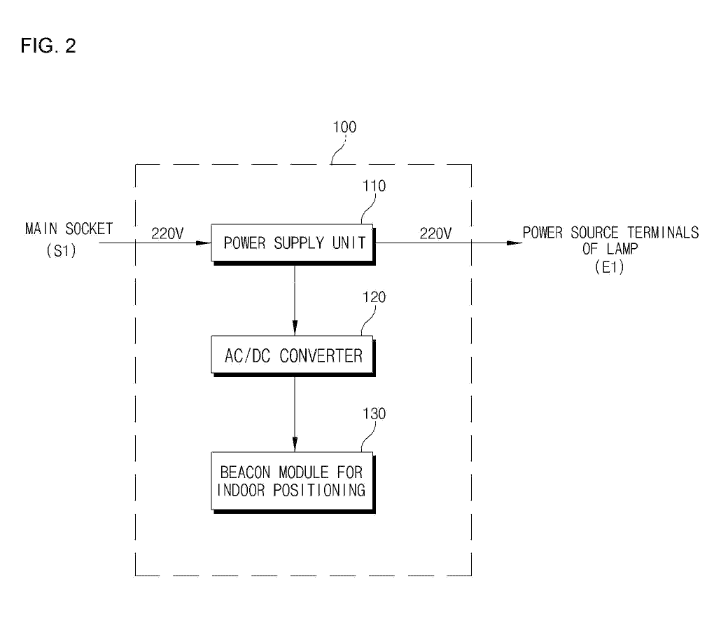

FIGS. 1 and 2 are diagrams illustrating a fluorescent socket connector according to an exemplary embodiment of the present invention.

Referring to FIG. 1, the fluorescent socket connector 100 according to an exemplary embodiment of the present invention has coupling grooves 100a and electrode terminals 100b. The coupling grooves 100a are provided in one side surface of a housing of the fluorescent socket connector 100 and are coupled with power source terminals (E1) of a Tri-phosphor fluorescent lamp (L1). The electrode terminals 100b are formed on the other side surface of the housing of the fluorescent socket connector 100 and receive supplying of a power source from a main socket (S1) fixed to a wall.

It is desirable that the coupling grooves 100a are constructed as a female socket of a form of being fitted to the power source terminals (E1) of the fluorescent lamp (L1), and it is desirable that the electrode terminals 100b are constructed as a male socket of a form of being plugged into the main socket (S1).

Accordingly, if the power source terminals (E1) of the fluorescent lamp (L1) are coupled to the coupling grooves 100a of the fluorescent socket connector 100, and the electrode terminals 100b of the fluorescent socket connector 100 are connected to the main socket (S1), a power source supplied from the main socket (S1) is applied to the power source terminals (E1) of the fluorescent lamp (L1) through the fluorescent socket connector 100 of the present invention and lights up the fluorescent lamp (L1).

Referring to FIG. 2, the fluorescent socket connector 100 of the present invention includes a power supply unit 110, an Alternating Current/Direct Current (AC/DC) converter 120, and a beacon module for indoor positioning 130. Operations of the respective constituent elements are described below in detail.

The power supply unit 110 supplies an AC power source, which is input from the main socket (S1), to the power source terminals (E1) of the fluorescent lamp (L1). The AC/DC converter 120 receives an input of the AC power source from the power supply unit 110, converts the received AC power source into a DC power source, and supplies a driving power source (for example, a voltage of 5 Voltage (V)) to the indoor positioning beacon module 130.

The indoor positioning beacon module 130 periodically wireless transmits a beacon signal including a beacon IDentifier (ID) to the external through a built-in antenna (not shown).

Here, the indoor positioning beacon module 130 can periodically wireless transmit a beacon signal including a beacon ID through all available wireless communication networks such as a Wireless Fidelity (WiFi) communication network, a Bluetooth communication network, a Zigbee communication network, a Long Term Evolution (LTE) communication network, a 3-Generation (3G) communication network and the like.

That is, the fluorescent socket connector 100 of the present invention applies the power source supplied from the main socket (S1), to the power source terminals (E1) of the fluorescent lamp (L1) to light up the fluorescent lamp (L1), while also playing a role of periodically wireless transmitting the beacon signal including the beacon ID to the external.

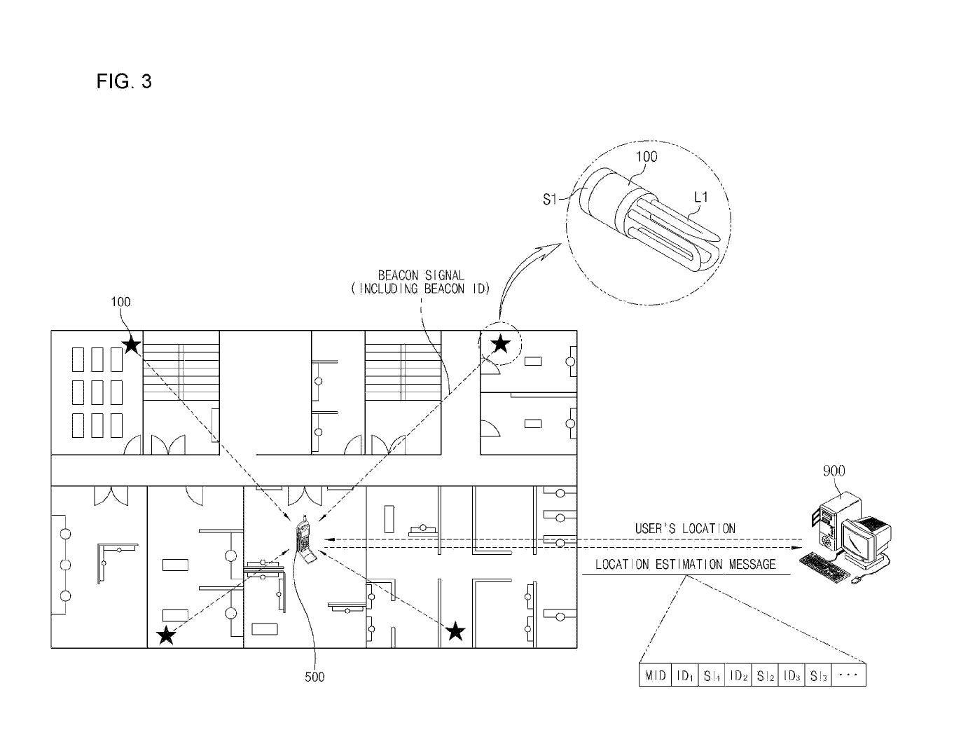

FIG. 3 is a diagram illustrating an indoor positioning system according to an exemplary embodiment of the present invention.

Referring to FIG. 3, if a fluorescent socket connector 100 of the present invention wireless transmits a beacon signal including a beacon ID to a portable terminal 500, the portable terminal 500 carried by a user within doors receives the beacon signal from the fluorescent socket connector 100 located around the portable terminal 500 through wireless communication.

Here, the portable terminal 500 refers to a terminal capable of, in a state where an indoor positioning application is executed, transmitting/receiving various data with the fluorescent socket connector 100 and an indoor positioning server 900 through the wireless communication. The portable terminal 500 can be any one of a tablet Personal Computer (PC) in which the wireless communication is possible and application installation is possible, a smart phone, a Personal Digital Assistant (PDA), and a mobile communication terminal. And, one or more fluorescent socket connector 100 can be located around the portable terminal 500 and therefore, the portable terminal 500 can receive beacon signals from the one or more fluorescent socket connectors 100, respectively.

The portable terminal 500 receiving the beacon signal extracts the beacon ID from the received beacon signal, detects a strength of the beacon signal, and stores the extracted beacon ID and the detected signal strength in a memory (not shown). The portable terminal 500 periodically includes the beacon ID and signal strength stored in the memory in a location estimation message and wireless transmits the location estimation message to the external positioning server 900.

In an exemplary embodiment, a header of the location estimation message includes identification information (i.e., a Manufacturer's IDentification number (MID)) of the portable terminal 500, and a body of the location estimation message includes beacon IDs (ID₁, ID₂, ID₃, . . . ) acquired from respective beacon signals and strengths (SI₁, SI₂, SI₃, . . . ) of the beacon signals.

If the portable terminal 500 wireless transmits a location estimation message to the external positioning server 900, the external positioning server 900 receives the location estimation message from the portable terminal 500, determines a location of a user who carries the portable terminal 500 on the basis of information included in the location estimation message, maps the determined location of the user on a map, and transmits the mapped location of the user to the portable terminal 500.

In an exemplary embodiment, the positioning server 900 may transmit the location of the user to external systems (e.g., building management systems, fire rescue systems, public institutions, information provision systems and the like).

That is, the present invention can detect an accurate current location of a user who carries a portable terminal using the fluorescent socket connector 100 equipped with the indoor positioning beacon module 130 and accordingly, can simply build an indoor positioning system at a low cost compared to the related art.

Further, the present invention can detect an accurate current location of a user who carries a portable terminal on the basis of strengths of beacon signals received from one or more fluorescent socket connectors 100. Therefore, when a fire or an emergency occurs within a building, the present invention can rapidly detect location information of users and evacuate the users even without going to check if there are persons within doors one by one and thus, rapid lifesaving and initial response against the fire or emergency are made possible.

A structure of the fluorescent socket connector 100 of the present invention can be modified according to need. This is described below in detail.

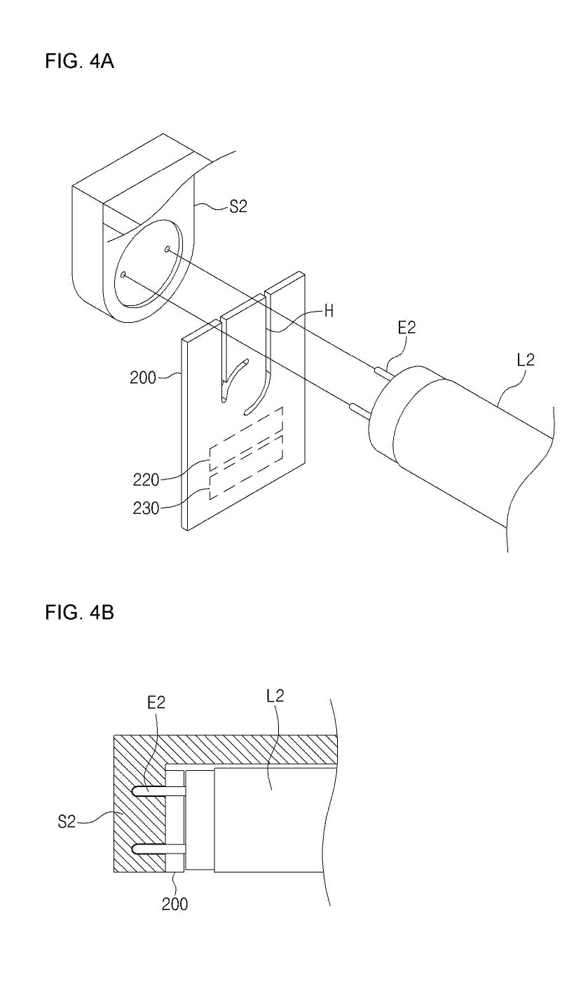

FIGS. 4A and 4B are diagrams illustrating a fluorescent socket connector 200 according to another exemplary embodiment of the present invention.

Referring to FIGS. 4A and 4B, the fluorescent socket connector 200 according to another exemplary embodiment of the present invention has the same constituent elements as the fluorescent socket connector 100 illustrated in FIG. 1 with the exception that the fluorescent socket connector 200 is of a card type and that the fluorescent socket connector 200 is coupled to a short-wavelength fluorescent lamp (L2), and has like operation performance and effects.

In other words, an AC/DC converter 220 and an indoor positioning beacon module 230 have the same constructions and operations as the AC/DC converter 120 and the indoor positioning beacon module 130 illustrated in FIG. 2. Unlike FIG. 2, in FIGS. 4A and 4B, a power supply unit is omitted since it is unnecessary in that the fluorescent socket connector 200 is of a card type and power source terminals (E2) of the short-wavelength fluorescent lamp (L2) are directly connected to a main socket (S2).

To avoid the duplication of description, this exemplary embodiment makes a description centering on a difference with the fluorescent socket connector 100 illustrated in FIG. 1.

First, the fluorescent socket connector 200 of the present invention has slit through-holes (H) capable of being fitted to the power source terminals (E2) of the short-wavelength fluorescent lamp (L2). A method of coupling the fluorescent socket connector 200 of the present invention to the power source terminals (E2) of the short-wavelength fluorescent lamp (L2) is described below in detail.

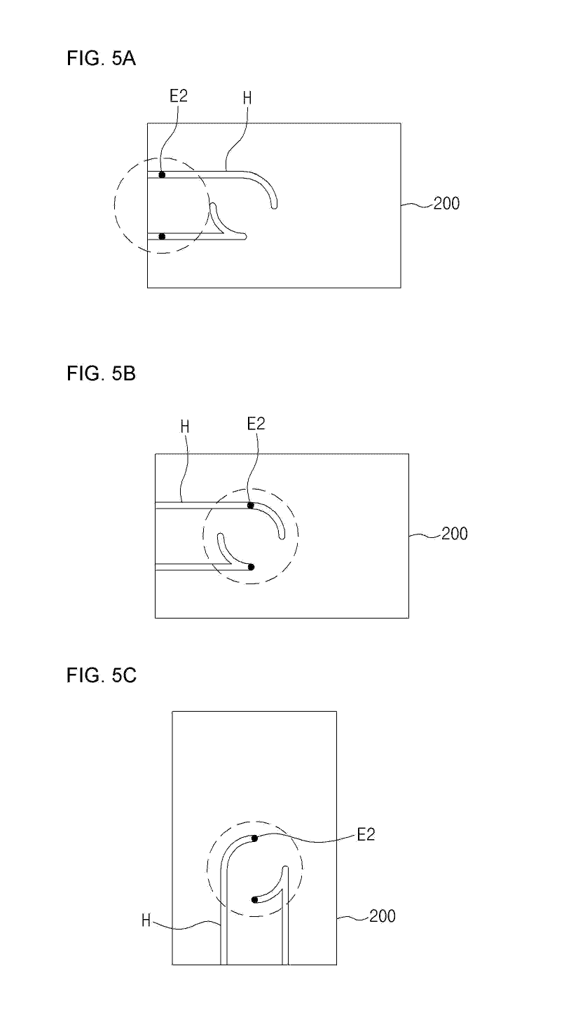

FIGS. 5A, 5B and 5C are diagrams for describing a method of coupling the fluorescent socket connector 200 of FIGS. 4A and 4B to the power source terminals (E2) of the short-wavelength fluorescent lamp (L2).

Referring to FIGS. 5A, 5B and 5C, as illustrated in FIG. 5A, the power source terminals (E2) of the short-wavelength fluorescent lamp (L2) are plugged into the slit through-holes (H) of the fluorescent socket connector 200 of the present invention. After that, as illustrated in FIG. 5B, the power source terminals (E2) of the short-wavelength fluorescent lamp (L2) are slid along the slit through-holes (H) of the fluorescent socket connector 200 until the power source terminals (E2) of the short-wavelength fluorescent lamp (L2) are caught by a catching jaw of the slit through-holes (H) of the fluorescent socket connector 200. Next, if the fluorescent socket connector 200 is rotated at 90 degrees as illustrated in FIG. 5C, the catching jaw of the slit through-holes (H) of the fluorescent socket connector 200 catches the power source terminals (E2) of the short-wavelength fluorescent lamp (L2) while the fluorescent socket connector 200 and the power source terminals (E2) get in point contact and electrically connect with each other.

In a state where the fluorescent socket connector 200 of the present invention is coupled to the power source terminals (E2) of the short-wavelength fluorescent lamp (L2), if the power source terminals (E2) of the short-wavelength fluorescent lamp (L2) are plugged into the main socket (S2), a power source supplied from the main socket (S2) is applied to the power source terminals (E2) of the short-wavelength fluorescent lamp (L2) and lights up the short-wavelength fluorescent lamp (L2).

At this time, the indoor positioning beacon module 230 wireless transmits a beacon signal including a beacon ID to the external through a built-in antenna (not shown).

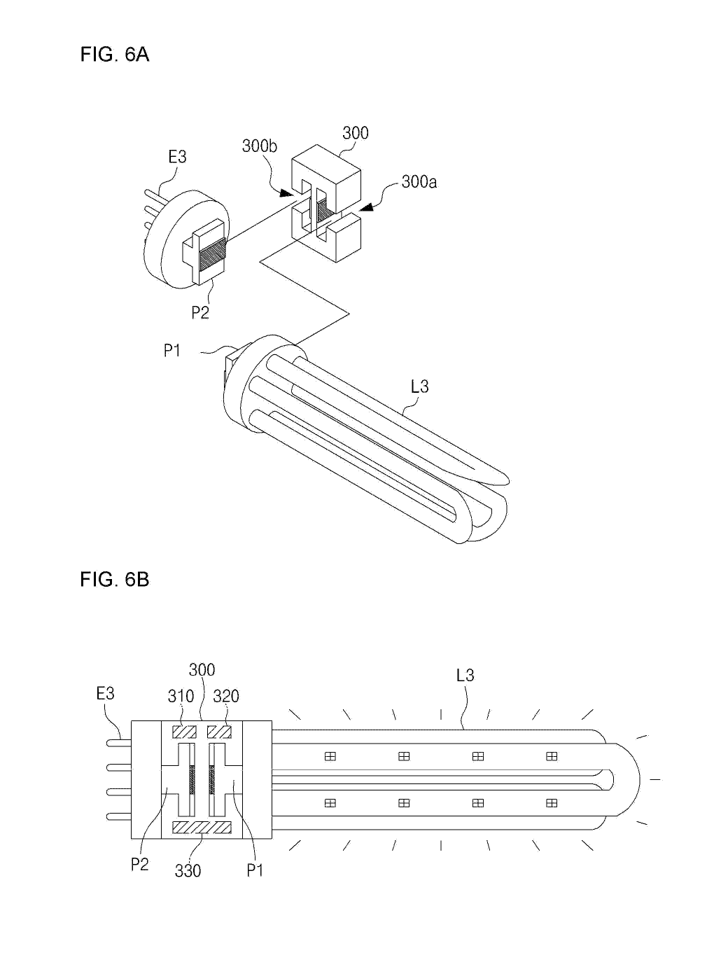

FIGS. 6A and 6B are diagrams illustrating fluorescent socket connectors 300 according to further exemplary embodiments of the present invention.

Referring to FIGS. 6A and 6B, the fluorescent socket connector 300 of the present invention has the same constituent elements as the fluorescent socket connector 100 illustrated in FIG. 1 with the exception that the fluorescent socket connector 300 is coupled to a Light Emitting Diode (LED) Tri-phosphor fluorescent lamp (L3), and has like operation performance and effects.

In other words, a power supply unit 310, an AC/DC converter 320, and a beacon module for indoor positioning 330 have the same constructions and operations as the power supply unit 110, the AC/DC converter 120, and the indoor positioning beacon module 130 illustrated in FIG. 2. To avoid the duplication of description, this exemplary embodiment makes a description centering on a difference with the fluorescent socket connector 100 illustrated in FIG. 1.

First, the fluorescent socket connector 300 has a 1st coupling through-hole 300a and a 2nd coupling through-hole 300b. The 1st coupling through-hole 300a is provided in one side surface of a housing of the fluorescent socket connector 300 and is coupled with the LED Tri-phosphor fluorescent lamp (L3). The 2nd coupling through-hole 300b is provided in the other side surface of the housing of the fluorescent socket connector 300 and is coupled with power source terminals (E3) of the LED Tri-phosphor fluorescent lamp (L3).

Here, it is desirable that the 1st coupling through-hole 300a is provided in a form capable of being coupled with a 1st connection part (P1) connected to the LED Tri-phosphor fluorescent lamp (L3), and it is desirable that the 2nd coupling through-hole 300b is provided in a form capable of being coupled with a 2nd connection part (P2) connected to the power source terminals (E3) of the LED Tri-phosphor fluorescent lamp (L3). Also, it is desirable that electrical contacts (shaded portions) are provided in coupling portions between the 1st coupling through-hole 300a and the 1st connection part (P1) and between the 2nd coupling through-hole 300b and the 2nd connection part (P2), respectively.

That is, in a state where the 1st connection part (P1) connected to the LED Tri-phosphor fluorescent lamp (L3) is coupled to the 1st coupling through-hole 300a of the fluorescent socket connector 300, and the 2nd connection part (P2) connected to the power source terminals (E3) of the LED Tri-phosphor fluorescent lamp (L3) is coupled to the 2nd coupling through-hole 300b of the fluorescent socket connector 300, if the power source terminals (E3) of the LED Tri-phosphor fluorescent lamp (L3) are connected to an external main socket (not shown), a power source supplied from the external main socket (not shown) is applied to the LED Tri-phosphor fluorescent lamp (L3) through the fluorescent socket connector 300 of the present invention and lights up the LED Tri-phosphor fluorescent lamp (L3).

At this time, the indoor positioning beacon module 330 wireless transmits a beacon signal including a beacon ID to the external through a built-in antenna (not shown).

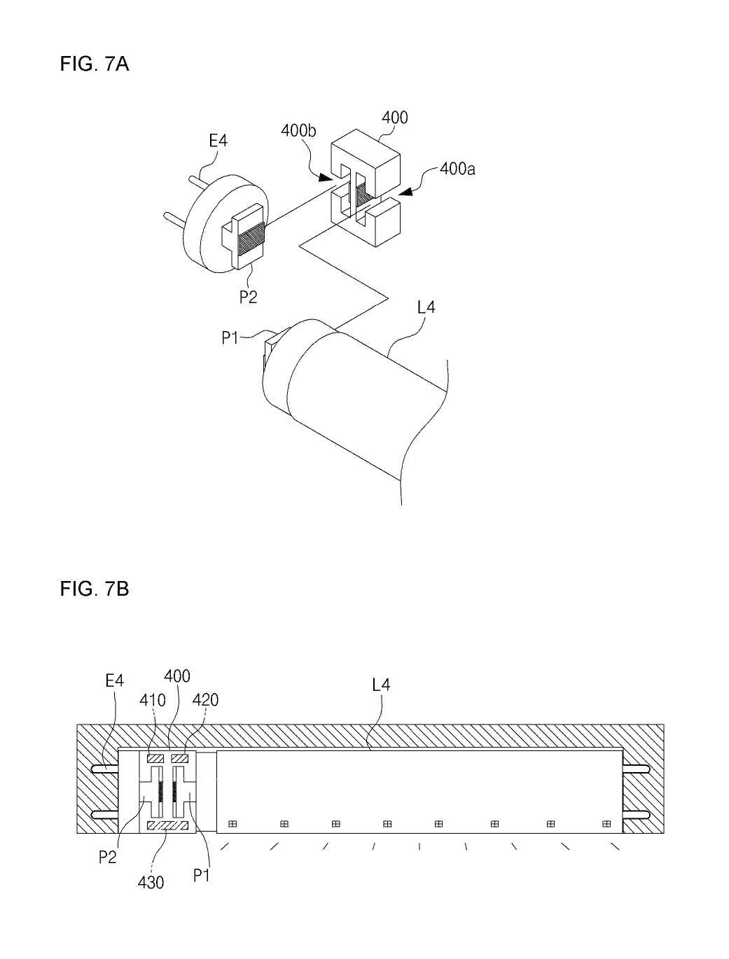

FIGS. 7A and 7B are diagrams illustrating fluorescent socket connectors 400 according to further exemplary embodiments of the present invention.

Referring to FIGS. 7A and 7B, the fluorescent socket connector 400 of the present invention has the same constituent elements as the fluorescent socket connector 300 illustrated in FIGS. 6A and 6B, excepting a difference that the fluorescent socket connector 400 is coupled to an LED short-wavelength fluorescent lamp (L4) instead of the LED Tri-phosphor fluorescent lamp (L3), and has like operation performance and effects.

As described above, exemplary embodiments of the present invention have an effect of being capable of simply building an indoor positioning system at a low cost compared to the related art, by installing a beacon module for indoor positioning in a fluorescent socket connector coupled to a fluorescent light to detect an accurate current location of a user who carries a portable terminal.

Also, exemplary embodiments of the present invention can detect an accurate current location of a user who carries a portable terminal on the basis of strengths of beacon signals received from one or more fluorescent socket connectors and thus, have an effect of, when a fire or an emergency occurs within a building, being capable of rapidly detecting location information of users who carry portable terminals and evacuate the users even without going to check if there are persons within doors one by one, and making possible rapid lifesaving and initial response against the fire or emergency.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A fluorescent socket connector comprising:
a power supply unit for supplying an Alternating Current (AC) power source input from a main socket, to power source terminals of a fluorescent lamp;
an AC/DC converter for receiving an input of the AC power source from the power supply unit, converting the received AC power source into a Direct Current (DC) power source, and supplying a driving power source to an indoor positioning beacon module; and
the indoor positioning beacon module for periodically wireless transmitting a beacon signal comprising a beacon IDentifier (ID) to the external,
wherein the fluorescent socket connector has a structure in which, in a state where the power source terminals of the fluorescent lamp are coupled to coupling grooves provided in one side surface of a housing of the fluorescent socket connector, if electrode terminals formed in the other side surface of the housing of the fluorescent socket connector are connected to the main socket, a power source supplied from the main socket is applied to the power source terminals of the fluorescent lamp through the electrode terminals and lights up the fluorescent lamp.

2. The socket connector of claim 1, wherein the coupling grooves are constructed as a female socket of a form of being fitted to the power source terminals of the fluorescent lamp, and the electrode terminals are constructed as a male socket of a form of being plugged into the main socket.

3. A fluorescent socket connector comprising:
an Alternating Current/Direct Current (AC/DC) converter for receiving an input of an AC power source from a main socket, converting the received AC power source into a DC power source, and supplying a driving power source to an indoor positioning beacon module; and
the indoor positioning beacon module for periodically wireless transmitting a beacon signal comprising a beacon IDentifier (ID) to the external,
wherein the fluorescent socket connector is of a card type having slit through-holes and, in a state where power source terminals of a fluorescent lamp are fixed and get in point contact with the slit through-holes, if the power source terminals of the fluorescent lamp are connected to the main socket, a power source supplied from the main socket is applied to the power source terminals of the fluorescent lamp and lights up the fluorescent lamp.

4. A fluorescent socket connector comprising:
a power supply unit for supplying an Alternating Current (AC) power source input from a main socket, to a Light Emitting Diode (LED) fluorescent lamp;
an AC/DC converter for receiving an input of the AC power source from the power supply unit, converting the received AC power source into a Direct Current (DC) power source, and supplying a driving power source to an indoor positioning beacon module; and
the indoor positioning beacon module for periodically wireless transmitting a beacon signal comprising a beacon IDentifier (ID) to the external,
wherein the fluorescent socket connector has a structure in which, in a state where the LED fluorescent lamp is coupled to a 1st coupling through-hole provided in one side surface of a housing of the fluorescent socket connector and power source terminals of the LED fluorescent lamp are coupled to a 2nd coupling through-hole provided in the other side surface of the housing of the fluorescent socket connector, if the power source terminals of the LED fluorescent lamp are connected to the main socket, a power source supplied from the main socket is applied to the LED fluorescent lamp and lights up the LED fluorescent lamp.

5. The socket connector of claim 4, wherein the 1st coupling through-hole is provided in a form capable of being coupled with a 1st connection part connected to the LED fluorescent lamp, and the 2nd coupling through-hole is provided in a form capable of being coupled with a 2nd connection part connected to the power source terminals of the LED fluorescent lamp, and electrical contacts are provided in coupling portions between the 1st coupling through-hole and the 1st connection part and between the 2nd coupling through-hole and the 2nd connection part, respectively.

6. An indoor positioning system comprising:
one or more fluorescent socket connectors coupled to fluorescent lights, and having indoor positioning beacon modules for periodically wireless transmitting beacon signals comprising beacon IDentifiers (IDs) to the external;
a portable terminal for receiving a beacon signal from the fluorescent socket connector located around the portable terminal through wireless communication, extracting a beacon ID from the received beacon signal, detecting a strength of the beacon signal, and storing the extracted beacon ID and the detected strength of the beacon signal in a memory, and periodically comprising each of the beacon ID and the strength stored in the memory in a location estimation message and wireless transmitting the location estimation message to the external; and
a positioning server for receiving the location estimation message from the portable terminal through the wireless communication, determining a location of a user who carries the portable terminal on the basis of information comprised in the received location estimation message, mapping the determined location of the user on a map, and wireless transmitting the mapped location to the portable terminal.

7. The indoor positioning system of claim 6, wherein, in a state where an indoor positioning application is executed, the portable terminal transmits/receives data with the fluorescent socket connector and the positioning server through the wireless communication.

8. The indoor positioning system of claim 6, wherein a head of the location estimation message comprises identification information of the portable terminal, and a body of the location estimation message comprises a beacon ID acquired from each beacon signal and a strength of the beacon signal.

9. The indoor positioning system of claim 6, wherein the fluorescent socket connector comprises:
a power supply unit for supplying an Alternating Current (AC) power source input from a main socket, to power source terminals of a fluorescent lamp;
an AC/DC converter for receiving an input of the AC power source from the power supply unit, converting the received AC power source into a Direct Current (DC) power source, and supplying a driving power source to the indoor positioning beacon module; and
the indoor positioning beacon module for periodically wireless transmitting the beacon signal comprising the beacon ID to the external,
wherein the fluorescent socket connector has a structure in which, in a state where the power source terminals of the fluorescent lamp are coupled to coupling grooves provided in one side surface of a housing of the fluorescent socket connector, if electrode terminals formed in the other side surface of the housing of the fluorescent socket connector are connected to the main socket, a power source supplied from the main socket is applied to the power source terminals of the fluorescent lamp through the electrode terminals and lights up the fluorescent lamp.

10. The indoor positioning system of claim 9, wherein the coupling grooves are constructed as a female socket of a form of being fitted to the power source terminals of the fluorescent lamp, and the electrode terminals are constructed as a male socket of a form of being plugged into the main socket.

11. The indoor positioning system of claim 6, wherein the fluorescent socket connector comprises:
an AC/DC converter for receiving an input of an AC power source from a main socket, converting the received AC power source into a DC power source, and supplying a driving power source to the indoor positioning beacon module; and
the indoor positioning beacon module for periodically wireless transmitting the beacon signal comprising the beacon ID to the external,
wherein the fluorescent socket connector is of a card type having slit through-holes and, in a state where power source terminals of a fluorescent lamp are fixed and get in point contact with the slit through-holes, if the power source terminals of the fluorescent lamp are connected to the main socket, a power source supplied from the main socket is applied to the power source terminals of the fluorescent lamp and lights up the fluorescent lamp.

12. The indoor positioning system of claim 6, wherein the fluorescent socket connector comprises:
a power supply unit for supplying an AC power source input from a main socket, to a Light Emitting Diode (LED) fluorescent lamp;
an AC/DC converter for receiving an input of the AC power source from the power supply unit, converting the received AC power source into a DC power source, and supplying a driving power source to the indoor positioning beacon module; and
the indoor positioning beacon module for periodically wireless transmitting the beacon signal comprising the beacon ID to the external,
wherein the fluorescent socket connector has a structure in which, in a state where the LED fluorescent lamp is coupled to a 1st coupling through-hole provided in one side surface of a housing of the fluorescent socket connector and power source terminals of the LED fluorescent lamp are coupled to a 2nd coupling through-hole provided in the other side surface of the housing of the fluorescent socket connector, if the power source terminals of the LED fluorescent lamp are connected to the main socket, a power source supplied from the main socket is applied to the LED fluorescent lamp and lights up the LED fluorescent lamp.

13. The indoor positioning system of claim 12, wherein the 1st coupling through-hole is provided in a form capable of being coupled with a 1st connection part connected to the LED fluorescent lamp, and the 2nd coupling through-hole is provided in a form capable of being coupled with a 2nd connection part connected to the power source terminals of the LED fluorescent lamp, and electrical contacts are provided in coupling portions between the 1st coupling through-hole and the 1st connection part and between the 2nd coupling through-hole and the 2nd connection part, respectively.
